(19) United States
(12) Patent Application Publication
(10) Pub. No.: US 2003/0022664 A1
(43) Pub. Date: Jan. 30, 2003

(54) Cellular apparatus and method for transmitting cellular signals

(76) Inventor: Tim Goldstein, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/912,121

(22) Filed: Jul. 24, 2001

(51) Int. Cl. H04M 3/00

(52) U.S. Cl. 455/420; 455/556; 455/426

(57) ABSTRACT

A cellular communication apparatus utilizes an antenna and control logic. The control logic is configured to monitor cellular signals detected by the antenna. The cellular signals are transmitted from cellular devices and identify the cellular devices. The control logic is further configured to receive a request to transmit to a remote cellular device and to make a determination, in response to the request, as to whether the remote cellular device is identified by one of the cellular signals detected by the antenna. The control logic is further configured to transmit a cellular signal based on the determination.

### BACKGROUND OF THE INVENTION

1. Field of the Invention

The present invention generally relates to cellular communication techniques and, in particular, to an apparatus and method for efficiently transmitting cellular signals to remote cellular devices at a reduced cost.

2. Related Art

Cellular communication devices, such as cellular telephones, for example, provide users the flexibility of communicating with other communication devices from any location serviced by a cellular service provider. Thus, a user of a cellular communication device can travel to many different locations while maintaining communication capabilities. The convenience and flexibility provided by cellular communication devices are generally well-known, and the use of cellular communication devices is becoming more widespread.

During communication with another device, a cellular communication device normally communicates with a cellular tower provided by a cellular service provider. The cellular tower communicates with a cellular network and/or other types of networks (e.g., the publicly switched telephone network or PSTN), which route data messages to and from the other device. Thus, to transmit a message to the other device, the cellular communication device transmits a message to a cellular tower, which interfaces the message with one or more communication networks. These communication networks, via well-known techniques, then route the message to the other device. If desired, the other device may transmit messages to the cellular device over the same path in the opposite direction.

Unfortunately, cellular service providers and/or operators of conventional communication networks charge fees for communicating messages over their equipment. As an example, a cellular user may be charged fees by the cellular service providers and/or the communication network operators based on the number of messages communicated during a cellular data session and/or based on a duration of the cellular data session. These fees can be relatively expensive and can significantly deter cellular users from using their cellular communication devices.

### SUMMARY OF THE INVENTION

Thus, a heretofore unaddressed need exists in the industry for providing a system and method for communicating with cellular devices while reducing the fees charged by cellular service providers and/or communication network operators. Generally, the present invention provides an apparatus and method for efficiently transmitting cellular signals to remote cellular devices at a reduced cost.

In architecture, the cellular transmission apparatus of the present invention utilizes an antenna and control logic. The control logic is configured to monitor cellular signals detected by the antenna. The cellular signals are transmitted from cellular devices and identify the cellular devices. The control logic is further configured to receive a request to transmit to a remote cellular device and to make a determination, in response to the request, as to whether the remote cellular device is identified by one of the cellular signals detected by the antenna. The control logic is further configured to transmit a cellular signal based on the determination.

The present invention can also be viewed as providing a cellular transmission method. The method can be broadly conceptualized by the following steps: detecting a transmission request at a cellular communication apparatus; determining, in response to the detecting step, whether a remote cellular communication device identified by the transmission request is within a transmission range of the cellular communication apparatus; and transmitting a cellular signal from the cellular communication apparatus to the remote cellular communication device identified by the transmission request.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 is a block diagram illustrating a conventional cellular communication system.

FIG. 2 is a block diagram illustrating a cellular communication system that employs a cellular apparatus in accordance with the present invention.

FIG. 3 is a block diagram illustrating a more detailed view of the cellular apparatus depicted in FIG. 2.

FIG. 4 is a block diagram illustrating another embodiment of the cellular communication system depicted by FIG. 2.

FIG. 5 is a flow chart illustrating an architecture and functionality of the cellular apparatus depicted in FIG. 2.

### DETAILED DESCRIPTION OF THE INVENTION

In general, the present invention provides a cellular apparatus and method for transmitting to a remote cellular device at a reduced cost. More specifically, a cellular communication apparatus, in accordance with the present invention, identifies one or more remote cellular communication devices that are within a close proximity such that the cellular communication apparatus of the present invention can transmit directly to the identified remote cellular devices. When data is to be transmitted to one of the identified remote cellular devices, the cellular apparatus of the present invention is designed to communicate the data directly to the one identified remote cellular device without utilizing a cellular tower. Thus, data is communicated to the one or more identified remote cellular devices without incurring fees typically charged by cellular service providers and/or communication network operators.

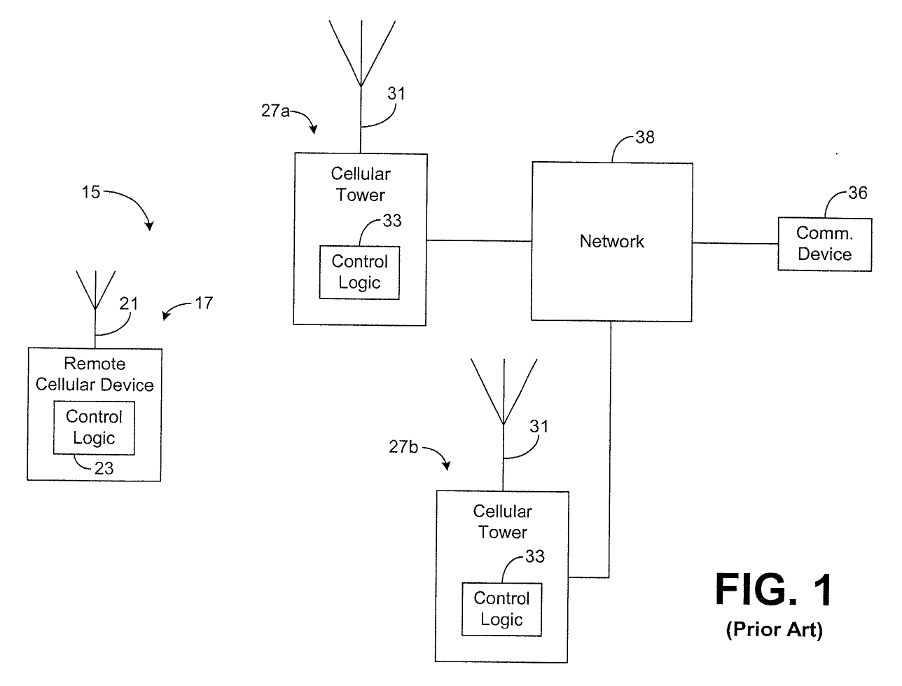

The cellular apparatus of the present invention is preferably configured such that it may operate within a conventional cellular environment, such as the conventional communication system 15 depicted in FIG. 1, without having to change the configuration of the other equipment within the conventional cellular environment. The system 15 shown by FIG. 1 includes a remote cellular communication device 17, such as, but not limited to, a cellular telephone or a cellular facsimile machine. The cellular device 17 includes an antenna 21 and control logic 23. The control logic 23 may be implemented in hardware, software, or a combination thereof and is designed to control the functionality and operation of the cellular device 17. The system 15 also includes a plurality of cellular towers 27a and 27b that each includes an antenna 31 and control logic 33. The control logic 33 may be implemented in hardware, software, or a combination thereof and is designed to control the functionality and operation of its respective cellular tower 27a or 27b. The cellular device 17 is often small and lightweight in order to make it portable, and the towers 27a and 27b are often large, non-mobile structures capable of simultaneously communicating with a relatively large number of cellular devices 17.

It is often desirable for the cellular device 17 to communicate with a remote communication device 36, which is normally interfaced with a network 38. The communication device 36 may be a cellular or non-cellular device. The network 38 includes conventional cellular and/or non-cellular networking equipment for routing signals to and from communication device 36.

To enable the occurrence of a data session between devices 17 and 36, the cellular device 17, prior to the data session, periodically communicates certain information with at least one of the cellular towers 27a or 27b. More specifically, each tower 27a and 27b is associated with a unique tower identifier that uniquely identifies the associated tower 27a or 27b, and each tower 27a and 27b transmits, via its respective antenna 31, tower identification signals that include the tower's unique tower identifier along with various other information. The type of other information transmitted along with the tower identifier is generally well-known in the art and is sufficiently described by numerous publicly available publications.

The cellular device 17 receives the tower identification signals transmitted from at least one of the towers 27a or 27b and selects one of the towers 27a or 27b as its primary tower. If the cellular device 17 receives a tower identification signal from only one tower 27a or 27b, then the device 17 selects this one tower 27a or 27b as its primary tower. If the cellular device 17 receives multiple tower identification signals from multiple towers 27a and 27b, then the device 17 determines which of the received signals is the strongest in terms of power. Normally, the tower identification signal transmitted from the closest tower 27a or 27b is strongest. The cellular device 17 then selects the tower 27a or 27b that transmitted the strongest tower identification signal as its primary tower. For illustrative purposes, assume that the cellular device 17 selects the tower 27a as its primary tower.

In addition, the cellular device 17 periodically transmits, via antenna 21, a service request signal that identifies the cellular device 17 and its primary tower 27a. In this regard, the cellular device 17 is associated with a unique identifier that uniquely identifies the cellular device 17. The service request signal periodically transmitted by the cellular device 17 includes the device's unique identifier and the tower identifier of the device's primary tower 27a. The foregoing service request signal normally includes other information that will not be further described in detail herein.

The primary tower 27a, via antenna 31, should receive the service request signal transmitted by the cellular device 17. Based on the unique identifier and the tower identifier included in this signal, the tower 27a identifies the cellular device 17 and determines that it has been selected to provide cellular service to the identified device 17. The tower 27a then notifies the network 38 of this information, and in response, the network 38 routes any message destined for the device 17 to the tower 27a. Any message destined for the device 17 and routed to the tower 27a is communicated to the device 17 by the tower 27a, as will be described in further detail hereinbelow.

After the device 17 and its primary tower 27a have exchanged identification signals as described above, communication between the cellular device 17 and the communication device 36 may occur. As an example, to call cellular device 17, the communication device 36 transmits a signal that includes the unique identifier of the cellular device 17. The network 38 routes this signal to tower 27a. In response, the tower 27a transmits a signal that includes the unique identifier of the cellular device 17 along with other information that is to be processed by the device 17. This other information is normally provided by communication device 36. For example, when the device 36 is a telephone, the other information included in the signal transmitted by the tower 27a may be voice data generated by the device 36. In another embodiment, the device 36 may be a computer, and the other information included in the signal transmitted from the tower 27a may be graphical data or some other type of data transmitted from device 36. There are various other types of data and information that may be included in the signal transmitted from the tower 27a.

The cellular device 17 continuously monitors the signals detected by its antenna 31, and when the device 17 receives, from the tower 27a, a signal that includes its unique identifier, the device 17 further processes the other information that is included in the signal. For example, as described above, the other information in the signal transmitted from the tower 27a may be voice data that is transmitted from communication device 36. In this case, the cellular device 17 converts this voice data into sound via a speaker (not shown) included within the device 17 so that the user of the device 17 can hear the sound defined by the voice data. If the other information in the signal transmitted from tower 27a is graphical data, then the cellular device 17 may include a display (not shown) that converts the graphical data into an image displayed to the user. There are other types of information that may be processed by the cellular device 17 according to techniques well-known in the art.

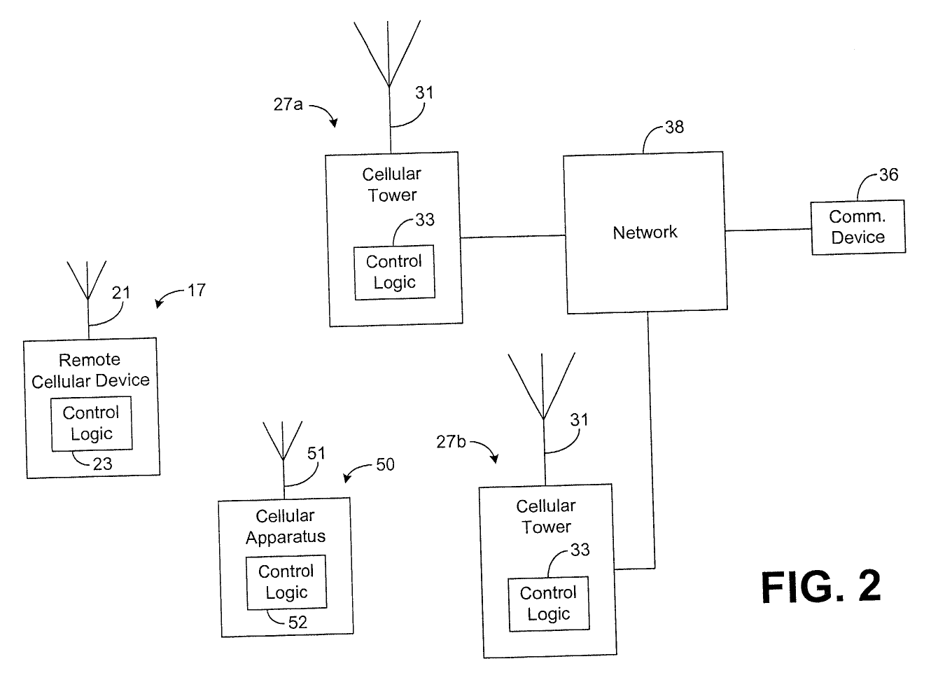

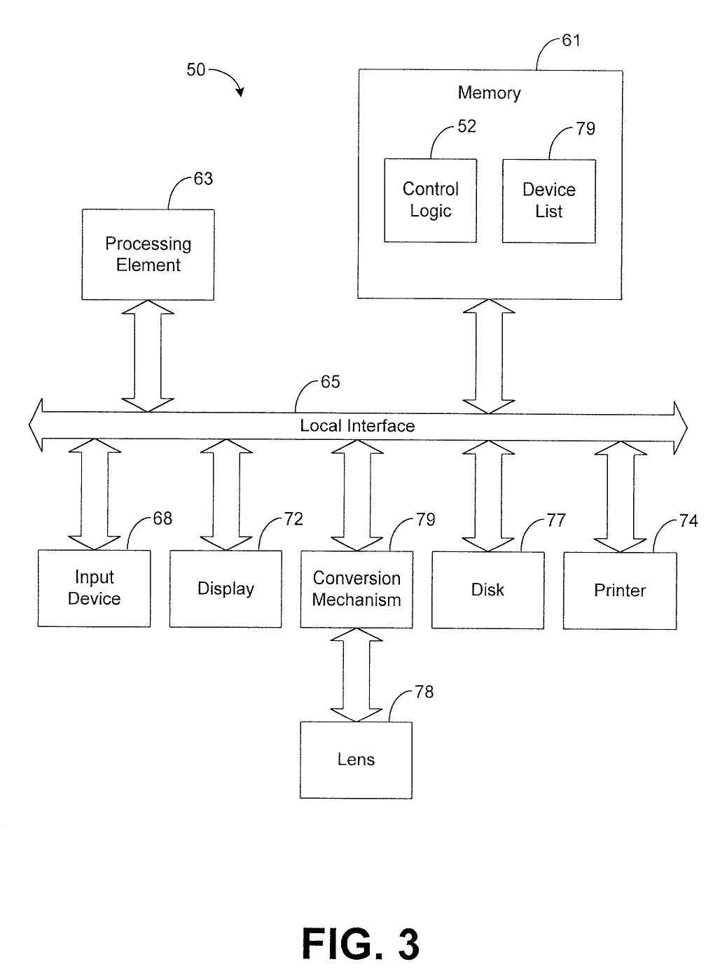

FIG. 2 depicts a cellular apparatus 50 that may be utilized to implement the present invention. As shown by FIG. 2, the apparatus 50 includes an antenna 51 and control logic 52, which is configured to control the functionality and operation of the apparatus 50. The control logic 52 can be implemented in software, hardware, or a combination thereof. In the preferred embodiment, as illustrated by way of example in FIG. 3, the control logic 52 along with its associated methodology is implemented in software and stored in memory 61.

Note that the control logic 52, when implemented in software, can be stored and transported on any computer-readable medium for use by or in connection with an instruction execution system, such as a computer-based system, processor-containing system, or other system that can fetch the instructions from the instruction execution system, and execute the instructions. In the context of this document, a “computer-readable medium” can be any means that can contain, store, communicate, propagate, or transport the program for use by or in connection with the instruction execution system. The computer readable medium can be, for example but not limited to, an electronic, magnetic, optical, electromagnetic, infrared, or semiconductor system or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in memory. As an example, the control logic 52 may be magnetically stored and transported on a conventional portable computer diskette.

The preferred embodiment of the cellular apparatus 50 of FIG. 3 comprises one or more conventional processing elements 63, such as a digital signal processor (DSP) or a central processing unit (CPU), for example, that communicate to and drive the other elements within the apparatus 50 via a local interface 65, which can include one or more buses. Furthermore, an input device 68, for example, a keypad or a mouse, can be used to input data from a user of the apparatus 50, and a display unit 72 or a printer 74 can be used to output data to the user. A disk storage mechanism 77 can be connected to the local interface 65 to transfer data to and from a nonvolatile disk (e.g., magnetic, optical, etc.).

The cellular apparatus 50 may be implemented as a digital camera, in which case the apparatus 50 may include a lens 78 for receiving light and a conversion mechanism 79 for converting the light into digital data. This digital data may then be transmitted by the cellular device's antenna 51 within a cellular signal. In another embodiment, the cellular apparatus 50 may be implemented as a telephone, in which case the apparatus 50 may include one or more speakers (not shown) for producing sound based on voice data within a cellular signal received by its antenna 51. In this embodiment, the cellular device 50 may also include a microphone (not shown) for producing voice data to be transmitted within a cellular signal via antenna 51. In yet another embodiment, the cellular apparatus 50 may be implemented as a facsimile machine or a scanner, in which case the apparatus 50 may include a scanning unit (not shown) for scanning data to be transmitted within a cellular signal via antenna 51. There are various other types of the devices that may be implemented by the cellular apparatus 50.

The cellular apparatus 50 is preferably configured similar to the conventional cellular device 17 in that the apparatus 50 is capable of communicating cellular signals with one of the cellular towers 27a or 27b according to the conventional techniques previously described. However, unlike conventional device 17, the cellular apparatus 50 is further configured to detect when another cellular device, that is to receive a transmission from the apparatus 50, is located within the transmission range of the apparatus 50. In such a case, the apparatus 50 is configured to transmit data to the other device directly (i.e., without utilizing a cellular tower 27a or 27b), thereby avoiding the fees associated with usage of the towers 27a and 27b and/or with the network 38.

As an example, assume that the control logic 52 determines that a set of data should be transmitted to a conventional cellular device 17. Prior to transmitting this set of data, the control logic 52 monitors the signals detected by antenna 51. The control logic 52 analyzes these signals and identifies which cellular devices are within a geographic transmission range of the apparatus 50 based on these signals. For example, as previously set forth, the cellular device 17 is configured to periodically transmit a service request signal so that the its primary tower 27a may service the device 17, and this service request signal includes the unique identifier of the cellular device 17. If the cellular apparatus 50 of the present invention detects this signal (i.e., detects a service request signal that includes the unique identifier of the device 17), then the control logic 52 determines that the device 17 is within the transmission range of the apparatus 50.

To indicate that the device 17 is within the transmission range of apparatus 50, the control logic 52 preferably stores the unique identifier of the device 17 (i.e., the unique identifier received in the device's service request signal detected by antenna 51) into memory 61. In other words, the control logic 52 maintains, in memory 61, a device list 79 that identifies each cellular device 17 that is within the transmission range of apparatus 50. Thus, each cellular device 17 listed within device list 79 should be located within the transmission range of cellular apparatus 50. Note that the unique identifiers stored within memory 61 may be periodically cleared from memory 61 by the control logic 52 to ensure that a cellular device 17 is not included in the list 79 if the device 17 has recently moved outside the transmission range of apparatus 50.

Thus, when the cellular apparatus 50 of the present invention is ready to transmit a set of data to a remote cellular device 17, the control logic 52 first determines whether the remote device 17 is within the transmission range of cellular apparatus 50 by determining whether the apparatus 50 has recently received a service request signal from the remote device 17. In the preferred embodiment, the control logic 52 makes such a determination by determining whether the unique identifier of the remote device 17 is included in the device list 79. If the control logic 52 determines that the unique identifier of the device 17 is not within the list 79 and that the remote device 17 is, therefore, not within the transmission range of the apparatus 50, then the control logic 52 utilizes its primary tower 27a to transmit the foregoing set of data. Thus, the cellular apparatus 50 transmits the set of data to device 17 over cellular tower 27a and network 38 via conventional cellular transmission techniques.

However, if the control logic 52 determines that the unique identifier of the device 17 is included in the list 79 and that the remote device 17 is, therefore, within the transmission range of the apparatus 50, then the control logic 52 transmits the set of data within a cellular signal that includes the unique identifier of the remote device 17. This signal should not, however, include the tower identifier of tower 27a or be otherwise configured such that the tower 27a services the cellular signal. Therefore, the tower 27a should refrain from servicing the foregoing cellular signal transmitted by cellular apparatus 50. Moreover, the foregoing cellular signal, as transmitted by apparatus 50, should conform to the same protocol as a signal that is transmitted from the tower 27a to the device 17. Therefore, the device 17 should process the foregoing signal transmitted from apparatus 50 just as the remote device 17 would process a signal transmitted from its primary tower 27a. As a result, the remote device 17 should receive and process the set of data included in the signal transmitted directly from cellular apparatus 50, thereby eliminating the need for the apparatus 50 to transmit the data to the device 17 via the tower 27a and/or network 38. Accordingly, the user of the apparatus 50 should not be charged by a cellular service provider or a communication network operator for the transmission of the set of data to the remote device 17.

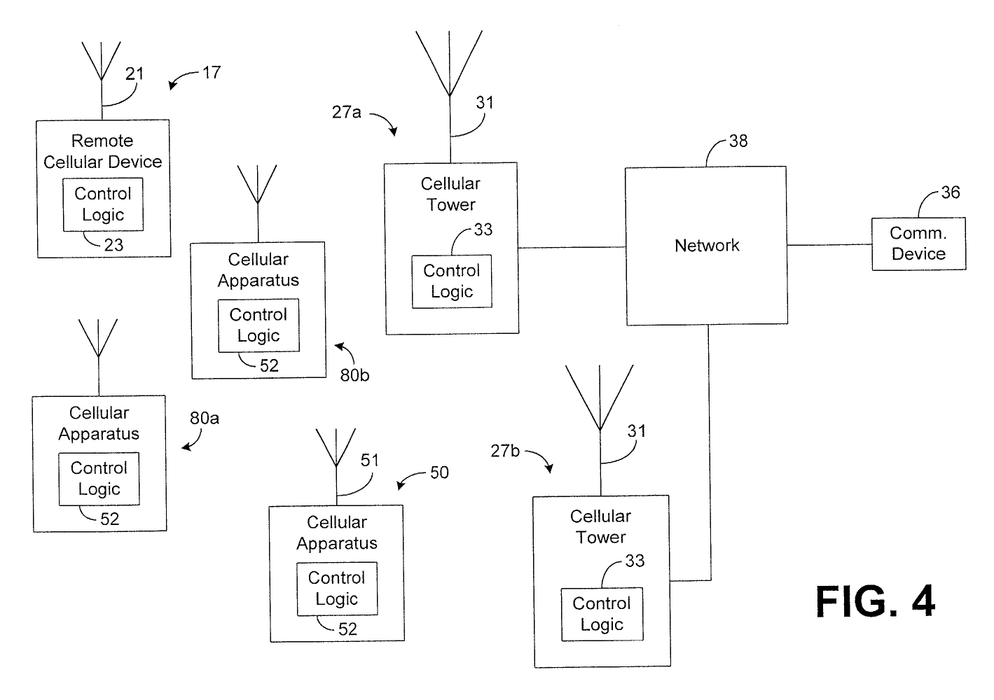

In the embodiment(s) described above, the apparatus 50 transmits a message to the remote cellular device 17, via the cellular tower 27a, when the apparatus 50 determines that the remote cellular device 17 is not within the transmission range of the apparatus 50. However, it is possible for one or more other cellular apparatuses or devices 80a and 80b configured similar or identical to apparatus 50 to be within the transmission range of device 17 and/or apparatus 50, as shown by FIG. 4. When the apparatus 50 is not within the transmission range of device 17, the apparatus 50 may be configured to transmit its message to the device 17 via one or more of the apparatuses 80a and/or 80b without utilizing conventional network 38 and conventional cellular towers 27a and 27b.

For example, if the device 17 is within the transmission range of apparatus 80a, which is within transmission range of apparatus 50, then the apparatus 50 may request the apparatus 80a to transmit its message to the remote cellular device 17. In this regard, the apparatus 50 may be configured to transmit the message directly to the apparatus 80a along with a request for the apparatus 80a to transmit the message to the remote cellular device 17. In response, the apparatus 80a transmits the message directly to the remote cellular device 17 without utilizing a conventional cellular tower via the same techniques described hereinabove for transmitting data from the apparatus 50 directly to the device 17. Thus, the message is successfully transmitted to the remote cellular device 17 without utilizing conventional network 38 and/or cellular towers 27a and 27b, even though the remote cellular device 17 is not within the transmission range of the apparatus 50.

It should be noted that any number of cellular apparatuses 80a and/or 80b may be utilized to transmit the message from the apparatus 50 to the remote cellular device 17. For example, the remote cellular device 17 may be within the transmission range of apparatus 80b, which is not within the transmission range of apparatus 50. However, apparatus 80b may be within the transmission range of the apparatus 80a that is within the transmission range of apparatus 50. Thus, the apparatus 50 may transmit the message directly to the cellular apparatus 80a, which then transmits the message directly to cellular apparatus 80b. Apparatus 80b then transmits the message to the remote cellular device 17. Note that other numbers of cellular devices 80a and 80b may be utilized to transmit the message to the remote cellular device 17. Also note that the apparatuses 50, 80a, and/or 80b may share information, such as the respective device lists 79 of the apparatuses 50, 80a, and/or 80b, among one another so that the apparatus 50 can determine whether or not the message can be successfully received by the remote cellular device 17 without utilizing cellular towers 27a and 27b. If the message cannot be successfully transmitted from the apparatus 50 to the device 17 (e.g., if the apparatuses 50, 80a, and/or 80b are not sufficiently positioned with respect to each other and with respect to device 17 such that a wireless communication link can be established between apparatus 50 and device 17 via apparatuses 80a and/or 80b), then the apparatus 50 preferably transmits the message to the remote cellular device 17 utilizing cellular towers 27a and/or 27b via conventional techniques.

It should be further noted that there are various methodologies, other than those described above, that may be employed in order for the cellular apparatus 50 to determine whether a remote cellular device 17 is within the transmission range of the apparatus 50. For example, the device 17 may be modified to negotiate directly with apparatus 50, if the device 17 is within communication range of the apparatus 50. Thus, signals other than service request signals may be utilized to determine whether or not the device 17 is within the transmission range of the cellular apparatus 50.

OPERATION

The preferred use and operation of the cellular apparatus 50 and associated methodology are described hereafter.

Assume, for illustrative purposes, that the cellular apparatus 50 is a digital camera capable of taking a picture and transmitting the picture over a cellular channel. Further assume, for illustrative purposes, that a user of the cellular apparatus 50 would like to take a picture and to transmit the picture to the remote cellular device 17.

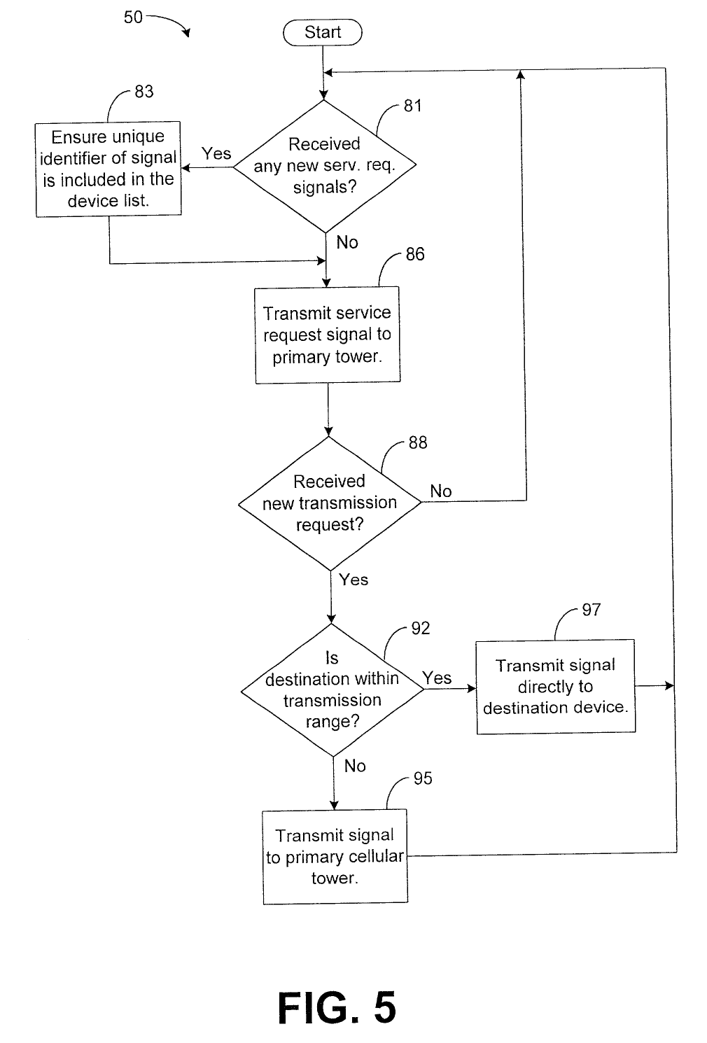

As shown by block 81 of FIG. 5, the cellular apparatus 50 monitors the signals detected by antenna 51 to determine whether the antenna 51 receives a service request signal transmitted by remote cellular devices. Such signals are normally transmitted from remote cellular devices in order to request service from their primary towers, as previously described hereinabove. If the antenna 51 receives a service request signal from a remote cellular device, the control logic 52 in block 83 stores the unique identifier within the service request signal into memory 61. In the present example, assume that the remote cellular device 17 is close enough to the apparatus 50 so that the antenna 51 receives the service request signals transmitted from device 17. In response to a service request signal from remote device 17, the control logic 52 should extract the unique identifier of the remote device 17 from the service request signal and add the extracted identifier to the device list 79 in block 83. The list 79 should, therefore, identify device 17, thereby indicating that the device 17 is within the transmission range of the cellular apparatus 50.

As shown by block 86, the control logic 52 periodically transmits a service request signal to its primary tower 27a or 27b so that the apparatus 50 is capable of communicating with its primary tower 27a or 27b over cellular channels according to conventional methodologies, if necessary. For illustrative purposes, assume that the primary tower of apparatus 50 is tower 27b.

At some point, the user of the cellular apparatus 50 takes a picture. Therefore, the apparatus 50, through conventional techniques, captures a set of digital data defining the picture taken by the user. In order to transmit this set of digital data to the remote cellular device 17, the user inputs or selects the unique identifier of the remote device 17 via input device 68 (FIG. 3). In response, the control logic 52 determines whether or not the device 17 identified by the foregoing unique identifier is within the transmission range of the apparatus 50, as shown by blocks 88 and 92 of FIG. 5. In the preferred embodiment, the control logic 52 makes such a determination by analyzing the device list 79 to determine whether or not the unique identifier provided or selected by the user is included in the list 79. If the foregoing unique identifier is not included in the list, then the control logic 52 would determine that the remote device 17 is not within the transmission range of the apparatus 50 and, would therefore, transmit the set of digital data to the device 17 via conventional cellular techniques, as shown by block 95. In other words, the apparatus 50 would transmit, to its primary tower 27b, a cellular signal that includes the set of digital data. The signal would then be routed to the primary tower 27a of the remote device 17. The tower 27a would then transmit the set of data to the remote cellular device 17. As a result, the user of apparatus 50 would incur fees charged by cellular service providers and/or communication network operators.

However, in the present example, the remote device 17 is close enough to the apparatus 50 such that the apparatus 50 receives the service request signals transmitted by the remote device 17. Thus, the control logic 52 should have added the unique identifier of the device 17 to the device list 79 in block 83. Therefore, in block 92, the control logic 52 determines that the device 17 identified by the unique identifier provided or selected by the user of the apparatus 50 is within the transmission range of the apparatus 50. In response, the control logic 52 transmits a cellular signal that includes the unique identifier of the device 17 (i.e., the unique identifier provided or selected by the user) and the set of digital data. Since the remote device 17 should be within the transmission range of apparatus 50, the device 17 should receive the foregoing cellular signal, which conforms to the same protocol that would have been used by the tower 27a to communicate a signal to device 17. Thus, when the remote device 17 receives the cellular signal transmitted from the apparatus 50, the remote device 17 processes the signal just as if the signal were transmitted by the tower 27a instead of the apparatus 50.

As an example, the device 17 may display the scene defined by the set of digital data included in the received cellular signal. Thus, by implementing the foregoing methodology, the user of the remote device 17 is able to view the picture taken by the user of apparatus 50. Since the apparatus 50 transmitted the data of the picture to the remote device 17 directly without utilizing any of the towers 27a or 27b and without utilizing network 38, the user of the apparatus 50 should not be charged by any cellular service providers or communication network operators for the transmission of the picture data to the remote communication device 17.

Now, therefore, the following is claimed:

1. A cellular apparatus, comprising:
an antenna; and
control logic configured to monitor cellular signals detected by said antenna, said cellular signals transmitted from cellular devices and identifying said cellular devices, said control logic further configured to receive a request to transmit to a remote cellular device and to make a determination, in response to said request, as to whether said remote cellular device is identified by one of said cellular signals detected by said antenna, said control logic further configured to transmit a cellular signal based on said determination.

2. The apparatus of claim 1, further comprising:
a lens; and
a conversion mechanism configured to convert light received via said lens into digital data,
wherein said control logic is configured to include said digital data in said cellular signal transmitted by said control logic.

3. The apparatus of claim 1, wherein said control logic is configured to transmit a service request signal to a cellular tower.

4. The apparatus of claim 1, wherein said control logic is further configured to include a cellular tower identifier in said cellular signal transmitted by said control logic, if said control logic fails to determine in said determination that said remote cellular device is identified by one of said signals detected by said antenna.

5. The apparatus of claim 1, wherein said control logic is further configured to define said cellular signal such that, if said control logic determines in said determination that said remote cellular device is identified by one of said signals detected by said antenna, any cellular tower that receives said cellular signal ignores said cellular signal.

6. The apparatus of claim 1, wherein said control logic is configured to define said cellular signal transmitted by control logic such that, if said control logic determines in said determination that said remote device is identified by one of said cellular signals detected by said antenna, said remote cellular device is responsive to said cellular signal transmitted by said control logic.

7. The apparatus of claim 6, wherein said control logic is configured to define said cellular signal transmitted by said control logic such that, if said control logic determines in said determination that said remote cellular device is not identified by one of said cellular signals detected by said antenna, a cellular tower is responsive to said cellular signal transmitted by said control logic.

8. A cellular apparatus for transmitting cellular signals, comprising:
an antenna; and
control logic configured to transmit, via said antenna, a cellular signal that identifies a remote cellular device, said control logic further configured to make a determination as to whether said remote cellular device is within a transmission range of said apparatus and to define said cellular signal based on said determination.

9. The apparatus of claim 8, wherein said apparatus further comprises:
a lens; and
a conversion mechanism configured to convert light received via said lens into digital data,
wherein said control logic is further configured to include said data in said cellular signal.

10. The apparatus of claim 8, wherein said control logic is configured to transmit a service request signal to a cellular tower.

11. The apparatus of claim 8, wherein said control logic is configured to detect whether said apparatus has received a cellular signal transmitted from said remote cellular device and to make said determination based on whether said control logic has detected said cellular signal transmitted from said remote cellular device.

12. The apparatus of claim 8, wherein said control logic is configured to transmit said cellular signal directly to said remote cellular device, if said control logic determines in said determination that said remote cellular device is within said transmission range.

13. The apparatus of claim 8, wherein said remote cellular device, based on said cellular signal, is configured to interface, with a user of said remote cellular device, data included in said cellular signal.

14. The apparatus of claim 8, wherein said control logic is configured to define said cellular signal such that a cellular tower is responsive to said cellular signal, if said control logic determines in said determination that said remote cellular device is not within said transmission range.

15. The apparatus of claim 14, wherein said control logic is configured to define said cellular signal such that said cellular tower is non-responsive to said cellular signal, if said control logic determines in said determination that said remote cellular device is within said transmission range.

16. A cellular transmission method, comprising the steps of:
monitoring cellular signals received by a cellular communication apparatus;
identifying a plurality of remote cellular communication devices based on said cellular signals monitored in said monitoring step;
detecting a transmission request at said cellular communication apparatus;
determining, in response to said detecting step, whether a remote cellular communication device identified by said transmission request has been identified in said identifying step; and
transmitting, based on said determining step, a cellular signal from said cellular communication apparatus to said remote cellular communication device identified by said transmission request.

17. The method of claim 16, further comprising the step of transmitting a request for service signal from said cellular communication apparatus to a cellular tower.

18. The method of claim 17, further comprising the step of defining said cellular signal transmitted in said transmitting step such that said cellular tower is non-responsive to said cellular signal.

19. The method of claim 16, further comprising the steps of:
capturing an image via said cellular communication apparatus;
defining said image in data; and
including said data in said cellular signal transmitted in said transmitting step.

20. A cellular transmission method, comprising the steps of:
detecting a transmission request at a cellular communication apparatus;
determining, in response to said detecting step, whether a remote cellular communication device identified by said transmission request is within a transmission range of said cellular communication apparatus; and
transmitting a cellular signal from said cellular communication apparatus to said remote cellular communication device identified by said transmission request.

21. The method of claim 20, further comprising the step of transmitting a service request signal from said cellular communication apparatus to a cellular tower.

22. The method of claim 20, farther comprising the steps of:
capturing an image via said cellular communication apparatus;
defining said image in data; and
including said data in said cellular signal transmitted in said transmitting step.

23. The method of claim 20, wherein said determining step includes the step of determining whether said cellular communication apparatus has received a signal transmitted from said remote cellular communication device.
